(19) United States
(12) Patent Application Publication
(10) Pub. No.: US 2014/0119852 A1
(43) Pub. Date: May 1, 2014

(54) ANTI-LOOSE SCREW

(71) Applicant: Sung Lung Lee, Taipei (TW)

(72) Inventor: Sung Lung Lee, Taipei (TW)

(21) Appl. No.: 13/665,933

(22) Filed: Nov. 1, 2012

(51) Int. Cl. F16B 35/04

(52) U.S. Cl. 411/412

(57) ABSTRACT

An anti-loose screw suitable for fastening various construction work pieces comprises: a screw head; a cylindrical rod, coupled to the screw head; a high thread and a low thread, spiraling around the cylindrical rod, and uniformly distributed on the cylindrical rod, wherein the crests of the low thread on the cylindrical rod are machined by a cutter to form cut slots and irregular burrs. When the screw is driven into a construction work piece, those two uniformly distributed high and low threads can keep the balance of the advancing screw so that the advancing screw can be free from any deviation. Further, the extruded scraps will be concentrated to provide a superior anchoring effect. Furthermore, in cooperation with the wrapping effect of the expanding material of the work piece, the cut slots and burrs formed via the machining of a cutter can raise the anti-loose capability of the screw.

The invention is a continuation in part (CIP) of the U.S. patent application Ser. No. 11/230,227, invented and assigned to the inventor of the present invention, and thus the contents of the U.S. patent application Ser. No. 11/230,227 are incorporated into the present invention as a part of the specification.

### BACKGROUND OF THE INVENTION

1. Field of the Invention

The present invention relates to anti-loose screws, wherein the crests of the low thread on the cylindrical rod of a screw are machined by a cutter to form cut slots and burrs; the threads of the screw will be wrapped by the expanding material of the work piece so that the screw can be tightly anchored inside the material; the anti-loose capability of the screw is further promoted by the cut slots and burrs lest the screw be loosened by vibrations or the aging effect.

2. Description of the Related Art

Screws have been indispensable mechanical elements in the modern age and are extensively used for the detachable fasteners. Screws not only have the fastening function but also can bear the load. Numerous variations of the screw have been evolved to meet different demands in various applications.

The screw itself has a relaxation torque, i.e. there is a reaction moment of relaxing the screw existing when the screw is being driven into a work piece. Refer to FIG. 1 a schematic view of a conventional screw. The screw 10 comprises: a screw head 11; a cylindrical rod 12, coupled to the screw head 11; and a thread 13, spiraling around the cylindrical rod 12. The screw 10 is to be used to join together two work pieces 20, 21 whose materials may be of various combinations, for example, both of them may be wooden, or one is wooden, and the other is metallic. A rotation force is applied to the screw head 11 to drive the screw 10 to enter into the work pieces 20, 21. With each turn of the screw 10, the thread 13 will advance into the work pieces 20, 21 by a pitch. Continuous rotation will finally drive the screw 10 to go into the work pieces 20, 21 completely, and thus, the screw-joining process of the work pieces 20, 21 is completed. The fastened screw can work for an interval of time; however, owing to the aging effect of time and the environment, the screw will have a tension relaxation or a free relaxation in the long run, which may incur the loosening of the screw.

Although the screw is not a precious element, it is really an important element. The screw-joining process plays a very important role and occupies a portion of time in an engineering task. The loosened screw not only damages the goodwill of an enterprise but also will bring about the user's loss. A responsible manufacturer should not ignore such a problem.

Accordingly, based on many years experience in this art and with the persistent study, the inventor proposes an anti-loose screw to overcome the problem of screw relaxation occurring in the conventional screw.

### SUMMARY OF THE INVENTION

Screws are a very important detachable element for the assembly, installation, and repair of a machine. The thread on a screw can help the screw enter into work pieces and has the functions of joining the work pieces together and bearing the load. The thread of a screw is like an inclined plane spiraling around the surface of a cylindrical rod and can help the user rotate the screw into a work piece. The denser the thread, the easier the driving of the screw, the better the engagement between the screw and the work piece, and the lower the probability of an unintentional loosing. Thus, to prevent a screw from loosing is to enhance the engagement between the screw and the work piece.

Owing to the aging effect of time and the environment, a conventional screw will have a tension relaxation or a free relaxation in the long run, which may incur the loosening of the screw and bring about the waste of time and cost.

The primary objective of the present invention is to provide an anti-loose screw, wherein the crests of the low thread are machined by a cutter to form cut slots and burrs in order to improve the anti-loose capability of the screw. The anti-loose screw of the present invention comprises: a screw head; a cylindrical rod, coupled to the screw head; a high thread and a low thread, spiraling around the cylindrical rod, and uniformly distributed on the cylindrical rod, wherein the crests of the low thread on the cylindrical rod are machined by a cutter to form cut slots symmetrically at both sides of the cylindrical rod with irregular burrs appearing in between the cut slots and the roots of the low thread, and those burrs range within two neighboring roots of the high thread. The cut slots and burrs can enhance the anti-loose capability of the screw.

Another objective of the present invention is to provide an anti-loose screw, wherein when the screw is being driven into a work piece, the material of the work piece is firstly expanded by the high thread uniformly distributed on the cylindrical rod, and then, the low thread uniformly distributed on the cylindrical rod is wrapped by the restored material; the cut slots at both sides of the cylindrical rod and the burrs formed by machining can provide an anti-loose resistance to anchor the screw lest the screw be loosened by vibrations or the aging effect.

Further objective of the present invention is to provide an anti-loose screw, wherein when the screw is being driven into a work piece, those two uniformly distributed high and low threads can keep the balance of the advancing screw so that the advancing screw can be free from any deviation; further, the extruded scraps will be concentrated to provide a superior anchoring effect, which can securely fix the screw inside the work piece.

Further another objective of the present invention is to provide an anti-loose screw, wherein a cutter is used to machine the crests of the low thread in order to form even and symmetric cut slots; the machining on the crests of the low thread is more time-saving than that on the crests of the high thread.

The anti-loose screw of the present invention utilizes the cut slots and the burrs to achieve the objective of preventing a screw from loosing. The present invention not only can provide a superior anchoring effective to overcome the problems of the conventional technology but also can save the cost and the fabrication time.

### BRIEF DESCRIPTION OF THE DRAWINGS

FIG. 1 is a schematic view of a conventional screw.

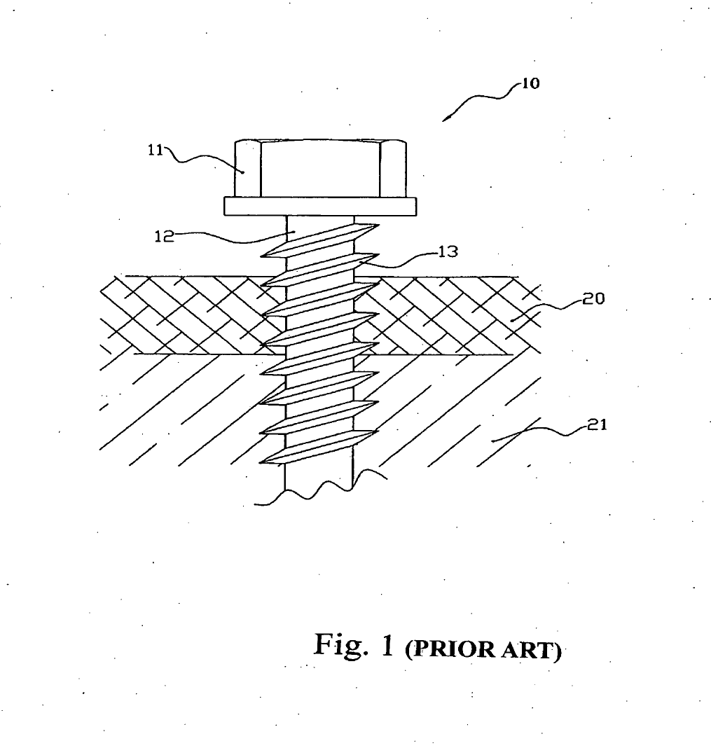

FIG. 2 is a schematic view of the structure of a screw.

FIG. 3 is a schematic view of the anti-loose screw of the present invention.

FIG. 4 is a partial enlarged view of the anti-loose screw of the present invention.

FIG. 5 is a view of one embodiment of the anti-loose screw of the present invention.

### DETAILED DESCRIPTION OF THE INVENTION

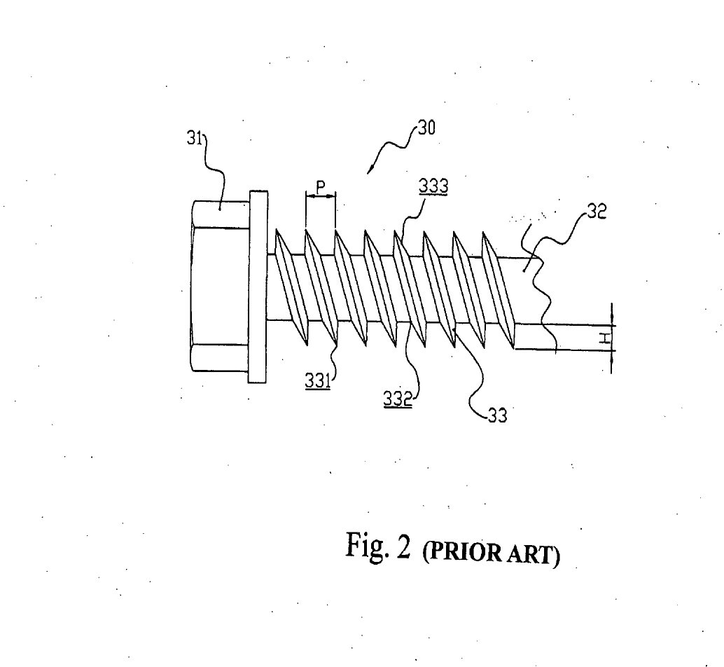

Refer to FIG. 2 a schematic view of the structure of a screw. The screw 30 comprises: a screw head 31; a cylindrical rod 32, coupled to the screw head 31; and a thread 33, spiraling around the cylindrical rod 32. The thread 33 has crests 331, roots 332 and flanks 333, wherein the crests 331 are the prominent portions of the thread 33; the roots are the bottom potions of the grooves; and the flanks 333 are the portions between the crests 331 and the roots 332. Those three portions form a V-shaped structure. The linear distance between the crest 331 and the root 332 is the height H of the screw 30. The horizontal distance measured from one point on the thread 33 to the adjacent corresponding point is the pitch P of the screw 30.

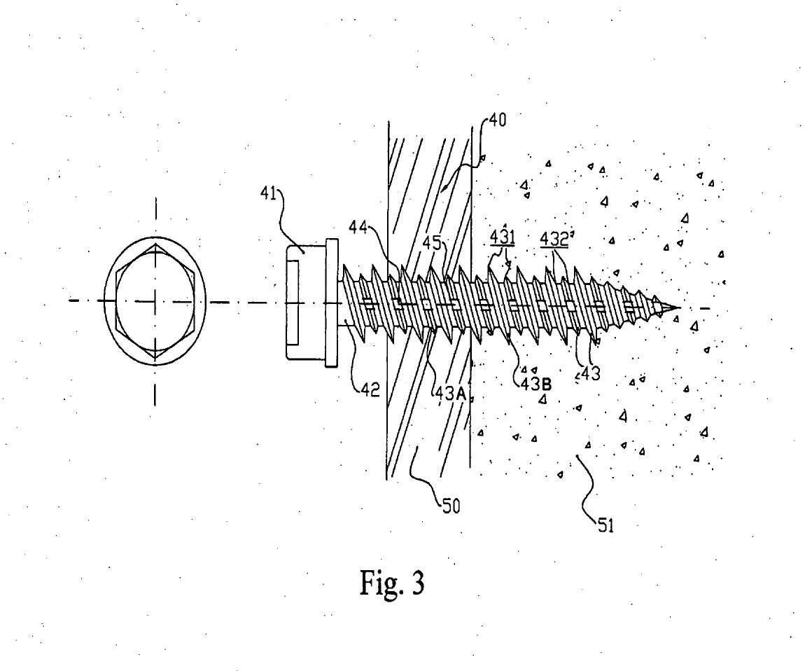

Refer to FIG. 3 a schematic view of the anti-loose screw of the present invention. The thread 43 on the screw 40 can help the user rotate the screw 40 into a work piece 50 and a work piece 51. The thread 43 also has the functions of joining together the work piece 50 and the work piece 51, and bearing the load. When the screw is being rotated into the work piece 50 and the work piece 51, the flanks function like an inclined plane and enable the user to easily rotate the screw 40 into the work piece 50 and the work piece 51. The smaller the pitch P, the less the force needed, and the better the engagement.

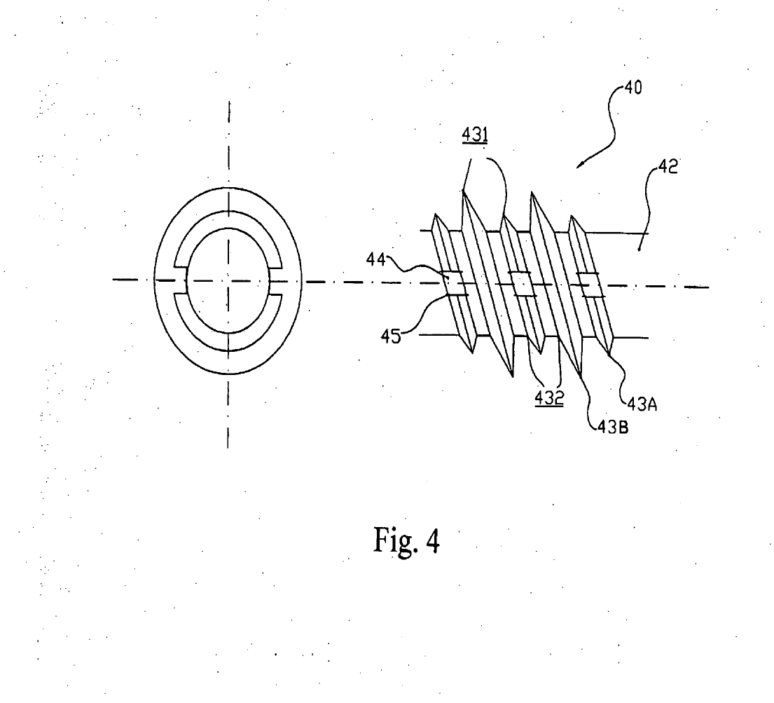

Refer to FIG. 4 a partial enlarged view of the anti-loose screw of the present invention. The anti-loose screw of the present invention comprises: a screw head 41; a cylindrical rod 42, coupled to the screw head 41; a low thread 43A and a high thread 43B, spiraling around the cylindrical rod 42, extending to the tip portion and uniformly distributed on the cylindrical rod 42. The external diameter of the high thread 43B is greater than that of the low thread 43A. The low thread 43A has multiple cut slots 44 separately at each turn of 180 degrees around the cylindrical rod 42; thus, the slots 44 are symmetrically disposed at both sides of the screw 40 and nor slot is on the high thread.

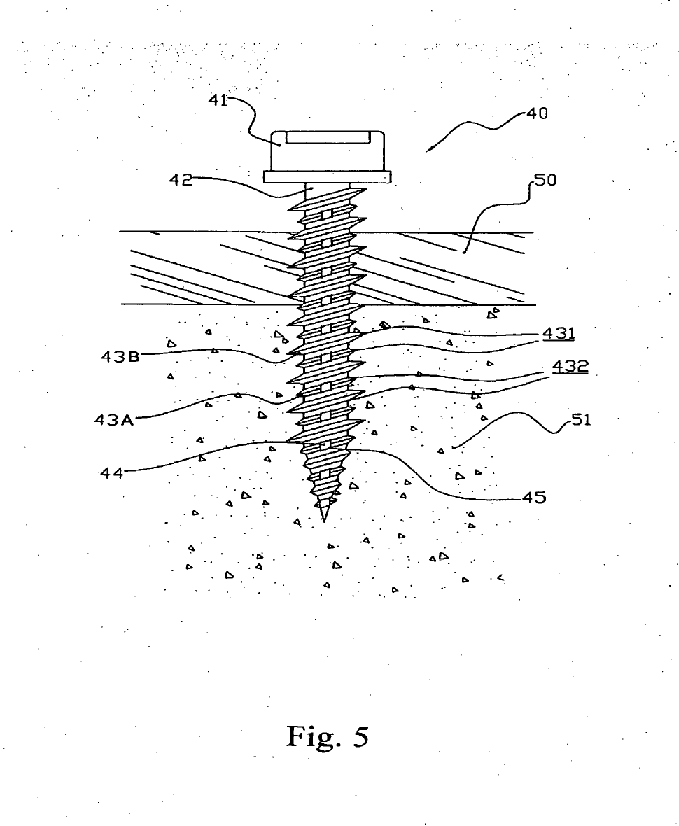

Refer to FIG. 5 a view of one embodiment of the present invention. The crests 431 of the low thread 43A are machined by a cutter to form cut slots 44 with irregular burrs 45 created in between the cut slots 44 and the roots 432 of the low thread 43A. The burrs 45 range within two neighboring roots 432 of the high thread 43B and do not interfere with the screw 40′s joining together the work piece 50 and the work piece 51. When the screw 40 is being driven into the work piece 50 and the work piece 51, the material of the work pieces 50, 51 will be expanded by the high thread 43B uniformly distributed on the cylindrical rod 42, and then, the extruded scraps of the work piece 50 and the work piece 51 will be concentrated to wrap the threads 43 of the screw 40. Further, the cut slots 44 and the burrs 45 disposed at both sides of the cylindrical rod 42 can provide an anchoring effect to increase the fastening force and the anti-loose capability of the screw 40 lest the screw 40 be loosened by vibrations or the aging effect.

When ‘the anti-loose screw of the present invention is being driven into a work piece, the low thread 43A and the high thread 43B uniformly distributed on the cylindrical rod 42 of the screw 40 can keep the balance of the advancing screw 40 so that the advancing screw 40 can be free from any deviation. In the present invention, the even and symmetric cut slots 44 are formed via machining the crests 431 of the low thread 43A by a cutter. As the crest 431 of the low thread 43A is more close to the cylindrical rod 42 than the crest 431 of the high thread 43B, the fabrication time can be saved obviously.

The anti-loose screw proposed by the present invention not only can overcome the problem of inferior anti-loose capability in the conventional screw and guarantee the fastening performance of the screw, but also can reduce the fabrication cost of the screw. Thus, the present invention has its non-obviousness.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A screw with anti-loosing properties comprising:
a screw head having a tapered shape with a large upper side and a tapered tip portion;
a cylindrical rod upwardly extending from the large upper side of the screw head;
a low thread and a high thread alternatively spiraling around the cylindrical rod and extending to the tip portion, and uniformly distributed on the cylindrical rod;
an external diameter of the high thread being greater than that of the low thread; and
wherein the low thread has multiple cut slots separately at each turn of 180 degrees around the cylindrical rod; thus, the slots are symmetrically disposed on the screw; and nor slot is on the high thread.

2. The screw with anti-loosing properties as claimed in claim 1, wherein the cylindrical rod has a round cross section and each slot has two parallel sides, a bottom side and an upper side; the bottom side of the slot is on a wall of the rod and the upper side of the slot is opened.
